(19) United States
(12) Patent Application Publication
(10) Pub. No.: US 2002/0187805 A1
(43) Pub. Date: Dec. 12, 2002

(54) Wireless telephone with illumination

(76) Inventor: Chang June Song, Richmond (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/877,333

(22) Filed: Jun. 7, 2001

(51) Int. Cl. H04B 1/38

(52) U.S. Cl. 455/556; 455/90

(57) ABSTRACT

A wireless telephone includes an illumination device mounted therein to provide light when a switch is actuated by finger actuation or by when a pivotally attached antenna is moved from a housed position that covers the illumination device to an extended position for telephone operation.

### BACKGROUND OF THE INVENTION

The present invention is directed generally to wireless telephones, and more particularly to wireless telephones with an illumination device.

As a result of the recent proliferation of cell phones, a significant number of the population now either carries them (i.e., cell phones) or uses them (e.g., in home or office). However, they can become a significant disadvantage when attempting to use one in lighting conditions that hinder the ability to see. For example, an attempt to read a telephone number on a piece of note paper, or from a notebook or address book, in dim light, can result in one can misread or misdial the number, resulting in extra and unnecessary charges for cell phone use. One solution is to use a flashlight, pen light, or other lighting device to illuminate number, but this can result in possibly dropping and damaging the telephone while fumbling to read the number.

Accordingly, there is a need to resolve cell phone use in dark or dimly-lit environments.

### BRIEF SUMMARY OF THE INVENTION

The present invention is directed to providing a wireless telephone integral with illumination.

According to a broad concept of the invention, a wireless telephone is formed from an enclosure to house the telephone electronics and an illumination device, such as a lamp, that is electrically connected, through a switch, to a battery also in the enclosure. A finger actuateable device is operated to activate the switch and communicate electrical current to the illumination device, producing light when desired.

In one embodiment of the invention, the antenna for the wireless telephone is pivotally mounted move from a recess of the enclosure of the wireless telephone to an extended position. Mounted proximate the recess to project light therefrom is the lamp. A finger actuateable switch lights the lamp so that it produces light that is projected from the recess of the wireless telephone. After use, the antenna may be pivoted back to its resting place in the recess, covering and protecting the lamp.

These, and other features and advantages of the invention will become apparent to those skilled in the art upon reading of the following detailed description of the invention, which should be taken in conjunction with the accompanying drawings.

### BRIEF DESCRIPTION OF THE DRAWINGS

FIG. 1 is a perspective view of a wireless telephone;

FIG. 2 is a representative view of the wireless telephone of FIG. 1, illustrating the circuitry used to selectively light the illumination devices shown as forming a part of the wireless telephone of in FIG. 1;

FIGS. 3 and 4 are representative view of a wireless telephone incorporating another embodiment of the present invention, showing a pivotally-attached antenna that swivels out from the housing of wireless telephone, when released, to expose an illumination element;

FIG. 5 is a detail of the slide member used as release mechanism for the antenna of the wireless telephone shown in FIGS. 3 and 4;

FIG. 6 a representative view of yet another a wireless telephone configured to incorporate still another embodiment of the present invention;

FIG. 7 is a detail of a slideable shutter used in the wireless telephone of FIG. 6 to both expose and actuate a lamp for projecting light therefrom; and

FIG. 8 is an shows the diffuser member used in the wireless telephone of FIG. 6 used to reduce luning.

### DETAILED DESCRIPTION OF THE INVENTION

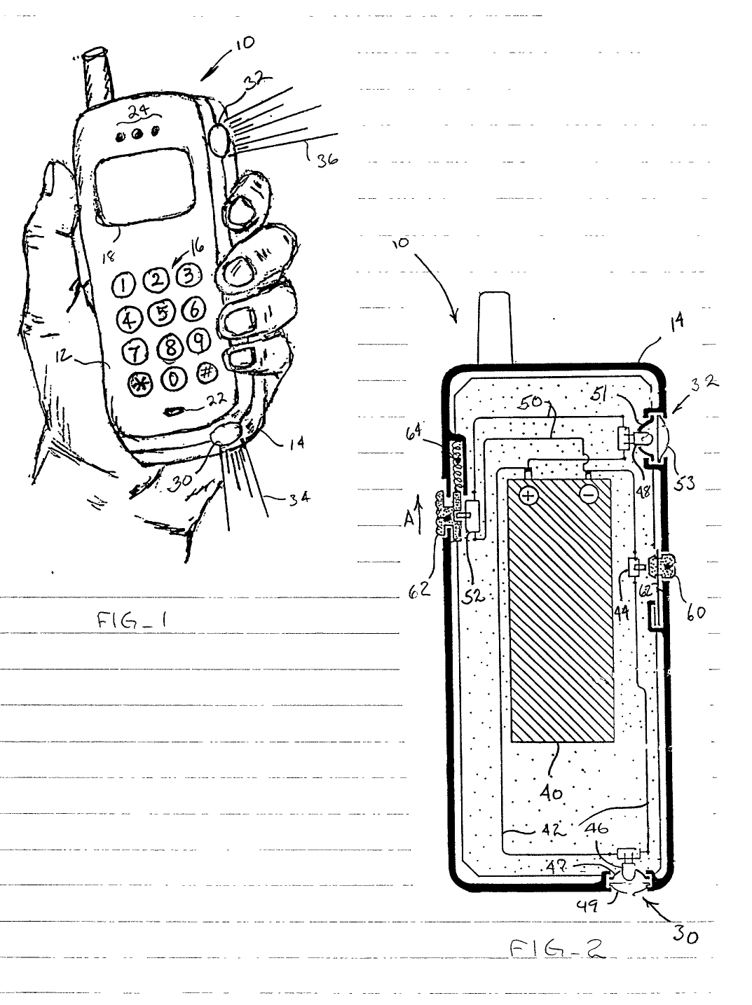

Turning now to the figures, and for the moment specifically FIGS. 1 and 2, an embodiment of the invention is illustrated. As FIG. 1 shows, a wireless phone, designated generally with the reference numeral 10, includes a two-part enclosure formed from a face plate 12 and back plate 14 which, together, house the necessary electronics for phone operation as well as the elements of the present invention. As is conventional, the face plate 12 carries the usual keyboard 16 and display 18, and has apertures 22, 24 formed therein for allowing ingress and egress of sound to a microphone (not shown) and from a speaker (not shown), respectively.

As FIG. 1 also shows, the wireless telephone 10 includes illumination elements 30, 32 which respectively project the light beams 34, 36.

Turning now to FIG. 2, a pictorial representation of the wireless telephone 10 without the front cover 12 is shown to illustrate the circuitry used to selectively activate the illumination elements 30, 32. The wireless telephone 10 includes, as is conventional, a battery 40 that is connected, by electrical wiring 42 and normally-open switch element 44, to a lamp 46 that forms a part of the illumination element 30. Similarly, wiring 50 and normally-open switch element 52 connect the battery 40 to a lamp 48 that forms a part of the illumination element 32.

As FIG. 2 further illustrates, the illumination element 30 includes a lamp holder 47 for the lamp 46, which may have a reflective surface so that it can act as a reflector to concentrate light produced by the lamp 46, and direct that light through a focussing lens 49. In similar fashion, the illumination element 32 mounts the lamp 48 in a reflector 51 for projecting light through a lens 53.

The lamps 46, 48 may be light emitting diodes (LEDs) or, alternatively, small, incandescent bulbs.

The switch element 44 is operated by the finger-depressible button 60. When depressed, the finger-depressible button 60 will cause the associated switch element 44 to close and complete a circuit path between the battery 40 and the lamp 46, producing light.

The switch element 52 is a slide switch that operates the switch element 52 to move it from its normally-open condition to a closed condition that completes a circuit between the battery 40 and the lamp 48 for illumination when the slide button 62 is moved in the direction of the arrow A against a bias mechanism (spring) 64.

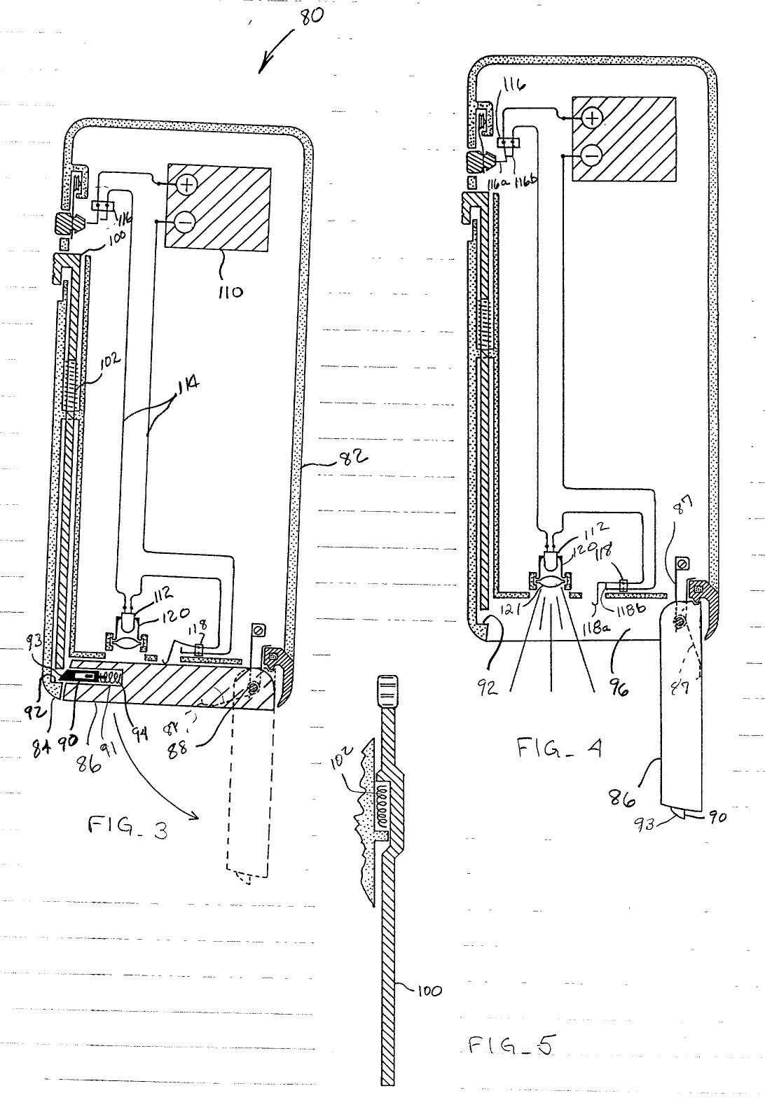

Turning now to FIGS. 3-5, another embodiment of the invention is pictorially represented. FIG. 3 illustrates a wireless telephone 80 only in terms of its back plate 82 and the elements necessary for the understanding of the present invention. It will be appreciated that a front plate (not shown) carrying a keyboard, display, and any other elements for telephone operation would complete the enclosure that houses the elements of the telephone. These elements and components are not shown in order to keep from unduly complicating the description of the invention and the drawings.

As FIG. 3 shows, the wireless telephone 80 has pivotally mounted at one end 84 an antenna holder 86, which houses the antenna (not shown) for the wireless telephone 80.

The antenna holder 86 is held in a closed position (as illustrated in FIG. 3) by a spring-loaded latch 90 that is contained in a recess 91 formed in the antenna holder 86. The latch is biased toward catch ledge 92 by a spring 94 to hold the antenna holder in a recess 96 (FIG. 4). A slide 100 is movable against a bias spring 102 toward the ledge 92 to push against the beveled edge 93 to urge the catch 90 away from the ledge 92 to release the antenna holder 86 so that it can revolve about the pivot point 88 into the extended position shown in FIG. 4 under the power of spring 87.

The wireless telephone 80 also includes a battery 110 that connects to a lamp 112 by electrical wiring 114 and switch elements 116 and 118.

The switch element 118 operates to arm the lamp 112 for activation when the antenna holder 86 is released to its extended (operating) position, completing a portion of the electrical circuit between the lamp and the battery 110. The remainder of the electrical circuit is completed when push button 117 is then depressed to close the switch 116, applying battery power to the lamp 112. Releasing the antenna holder 86 not only arms the lamp 112, but also exposes the lamp 112 so that its illumination, when the push button 117 is depressed, will project through focussing lens 121 (FIG. 4) and out recess 96.

The lamp 112 may be an LED or an incandescent type. Preferably, if an LED is used, the focussing lens 121 will operate to collimate the light produced by the lamp 112. Such lenses, however, are very delicate, and it is for that reason that the lamp is mounted in the recess 96 so that it can be protected by the antenna holder 86 when not in use.

The lamp 112 is mounted in a holder 120, which may also have a reflective surface facing the lamp in order to provide reflective, light-focussing capability. A focussing lens 121 is mounted in the light projection path of the lamp 112.

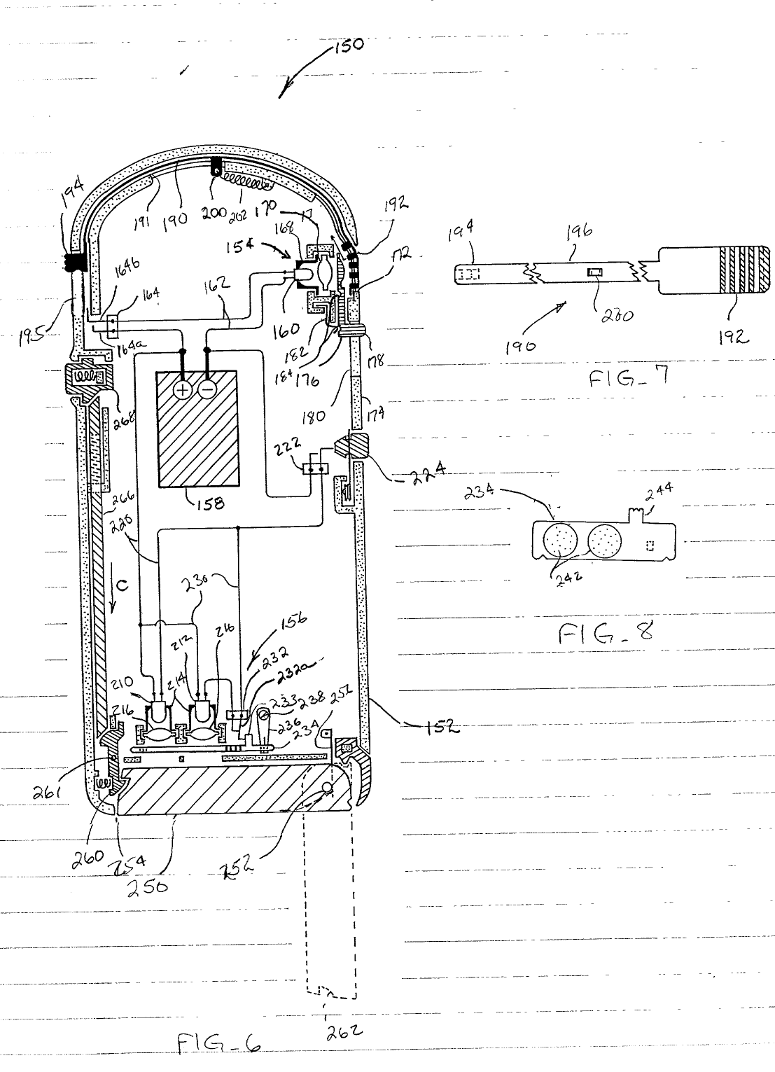

A further embodiment of the invention is illustrated in FIG. 6, and showing a wireless telephone 150 also with its front plate (not shown) removed in order to show only the back plate 152 and those components necessary to the understanding of the invention. The back plate 152 forms, with the front plate (not shown), an enclosure for the conventional operating electronics (not shown) of the wireless telephone and the elements that make up the illumination devices 154, 156 which are activated by a battery 158.

Turning first to the illumination device 154, a lamp (e.g. LED or incandescent lamp) 160 is electrically coupled to the battery 158 by electrical wiring 162 and a normally-open switch element 164. The lamp 160 is mounted in a holder 168 which preferably has a lamp-facing surface that is reflective to gather and focus the light produced by the lamp 160 for projection therefrom through a lens 170. If, as is sometimes the case of LEDs, the light generated by the lamp 170 is spectrum divided light, a correction may be preferred. If so, lens 170 is preferably structured to eliminate the spectrum. The light is then projected from the lens 170 and to and through an aperture 172 formed in a sidewall 174 of the back plate 152. If a tighter beam is desired, a focussing lens 176 may be mounted to the sidewall 174 for slideable movement into and out of the light projection field of the lamp 160. The focussing lens 176 has formed thereon a finger tab 178 that projects through opening 180 in the sidewall 174. Moving the finger tab 178 upward (as viewed in FIG. 6) moves the focusing lens into a position that allows it to receive and focus light from the lamp 160. A spring 182 forms a detent mechanism the capture and hold the focusing lens 176 is place by cooperative engagement with indentations 184 formed in the focusing lens structure.

The components of the illumination device 154, and particularly the lens 170, which may be very delicate, are both protected and operated by a shutter mechanism 190. As better shown in FIG. 7, the shutter mechanism 190 is formed to include an elongate, flexible body member 196, which has at one distal end a shutter portion 192, and a finger tab 194 at the other. An attachment post 200 is formed on the body member 196 for attachment to a bias mechanism (e.g., spring 202—FIG. 6) The shutter mechanism 190 is mounted for sliding movement in a channel 191 formed in the back plate 152 between a first position with the shutter portion 192 in effect closing the opening 172 to protect the components of the illumination device 154 and a second position that exposes the illumination device and engages switch element 164 to move switch arm 164b into electrical contact with switch arm 164a. The second position of the shutter mechanism, therefore, competes the electrical circuit through electrical wiring 162 to connect the battery 158 to the lamp 160. The shutter mechanism 190 is mounted so that finger tab 194 protrudes through an opening 195 so that a user can move the shutter movement.

The illumination device 158 of the wireless telephone 150 is shown as including a pair of lamps 210, 212 each of which is mounted in a holder 214, and each includes a spectrum elimination lens 216. The lamp 210 is connected to the battery 158 by electrical wiring 220 and a normally-open switch element 222. A spring-loaded finger button 224, when depressed, operates to complete the electrical circuit that applies current from the battery 158 to the lamp 210.

The lamp 212 also electrically connects to the battery 158 by electrical wiring 220 and switch 222 and, in addition, by electrical wiring 230 and arming switch 232.

Arming switch 232 is a normally-open switch connected to a swing arm 236 by a slide element 234. As shown in FIG. 6, the slide element 234 has formed to extend therefrom a flange 233 for engagement with a spring arm 232a of the arming switch 232. The spring arm 232a biases the slide element 234 to the right, as shown in FIG. 6. Moving the slide element 234 against the bias presented by the spring arm 232a will move the spring arm to close the switch 232 and complete that portion of the electrical circuit for lamp 212 comprising the electrical wiring 230 and switch 232. Thereby, the lamp 212 is “armed.”

But, the slide element 234 performs an additional function. As better illustrated in FIG. 8, the slide element is formed to include a pair of diffusing lenses 242. A finger tab 244 extends from the body member 240 to provide a user with a mechanism for moving the slide element 234 from its inactive position to the left (as viewed in FIG. 6) to electrically arm the lamp 212 as described above. When the slide element 234 is left in its inactive position, lamp 210 and lens 216 are exposed, but lamp 212 and associated lens 216 are not. Using the finger tab 244, which preferably extends through the front plate (not shown) of the wireless phone 150, the slide element 234 can be moved the arming position, and at the same time position the lens elements 242 in the field of light projection of both lamps 210, 212 (as shown in FIG. 6) to diffuse the light they produce and to inhibit or reduce “luning,” i.e., divergent and convergent overlap of the mononuclear beams produced by the separate lamps 210, 212.

Similar to the embodiment of the invention shown in FIGS. 3,4, the embodiment of FIG. 6 includes a pop-out antenna structure in the form of a box-like enclosure or holder 250 that houses the antenna (not shown) for the wireless telephone 150. The antenna holder 250 is mounted to pivot about a post 152 from a retracted or closed position to the extended position illustrated in phantom in FIG. 6. The closed position of the antenna holder 250 places the antenna holder (and the antenna it houses—not shown) a recess 254 of the back plate 152. (Of course, the front plate—not shown—would also have a recess, depending upon the configuration of the antenna holder). When housed in the recess 254, the antenna holder 250 is held against a bias spring 256 by a latch 260, which is configured to engage a cutout 262 formed in a distal end of the antenna holder 250. A slide bar 266 is urged downward in the direction of the arrow labeled “C” when a spring-loaded push button 268 is depressed, to pivot the latch 260 about a pinion 261, causing it to release the antenna holder 250 and allowing the bias spring 256 to force the antenna holder to the extended position.

When released, the antenna holder 250 then exposes the lamps 210, 212 to allow their illumination to be projected therefrom, through the recess 254, and outward.

What is claimed is:

1. A wireless telephone with illumination, including:
an enclosure having an aperture formed therein, the enclosure containing an illumination element mounted in the housing proximate the aperture,
a battery,
an electrical circuit, including a switch, the electrical circuit coupling the battery to the illumination element, the switch being in a normally open position to inhibit electrical connection between the battery and the illumination element; and
a finger-operable member mounted in association with the enclosure and operable by finger-actuation to cause the switch to establish electrical connection with the illumination element to produce illumination.

2. The wireless telephone of claim 1, wherein the finger-operable member is a finger-depressible switch.

3. The wireless telephone of claim 1, wherein the finger-operable member is a shutter mechanism that is movable from a first position that blocks the aperture and inhibits illumination emission from the from the housing to a second position that unblocks the aperture to permit illumination from the housing and to cause the switch to establish electrical connection between the battery and the illumination element.

4. The wireless telephone of claim 3, wherein the shutter mechanism is an elongate member having a first end to block illumination through the aperture when the finger-operable member is in the first position, and a second end for engagement with the switch when the finger-operable member is moved to the second position.

5. A wireless telephone, comprising:
an enclosure;
an antenna pivotally mounted to the enclosure for movement between a housed position and an extended position, the enclosure having a recess formed therein to receive the antenna when in the housed position;
an illumination mechanism mounted in the enclosure, the illumination mechanism including a battery, a lamp element, and an electrical circuit including a first switch having first and second positions to couple electric current from the battery to the lamp element when the first switch is in the second position, and to prevent electric current to the lamp element when the switch is in the first position, the lamp element being positioned to project light through the recess when the antenna is in its extended position.

6. The wireless telephone of claim 5, wherein the first switch is moved from the first position to the second position when the antenna is moved from the housed position to the extended position.

7. The wireless telephone of claim 6, the illumination mechanism including a second switch having a finger-actuateable mechanism to move the second switch to a position that, together with the first switch, completes an electrical circuit between the lamp element and the battery to cause the lamp to project light therefrom.

8. The wireless telephone of clam 7, wherein the finger-actuateable mechanism is a finger-depressible switch.

9. The wireless telephone of claim 7, wherein the first switch includes a lens moveable with the first switch from the first position to the second position to place the lens in a field of light projected from the lamp element when the first switch is moved to the second position.

10. The wireless telephone of claim 7, wherein the lamp element is a light-emitting diode.

11. The wireless telephone of claim 7, wherein the lamp element is an incandescent light.

12. The wireless telephone of claim 10, wherein the illumination mechanism includes a lens element to focus a light beam produced by the lamp element.

13. The wireless telephone of claim 12, wherein the lamp and lens elements are mounted to project the light beam out the recess when the antenna is in the extended position, the antenna operating to protect the lamp and lens elements when in the housed position.
